(19) United States
(12) Patent Application Publication
(10) Pub. No.: US 2010/0119142 A1
(43) Pub. Date: May 13, 2010

(54) Monitoring Multiple Similar Objects Using Image Templates

(76) Inventor: Sean Miceli, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/268,851

(22) Filed: Nov. 11, 2008

(51) Int. Cl. G06K 9/00; H04N 7/18

(52) U.S. Cl. 382/141; 348/86; 348/E07.085

(57) ABSTRACT

Computer-readable media having corresponding apparatus embodies instructions executable by a computer to perform a method comprising: capturing, with a first camera, a first image of a first one of a plurality of similar objects each having a common feature; generating an image template file based on the first image, wherein the image template file identifies a location of the feature of the first one of the plurality of similar objects in the first image; capturing, with a second camera, a second image of a second one of the plurality of similar objects; and controlling the second camera based on the second image and the image template file.

### FIELD

The present disclosure relates in general to image processing, and in particular to monitoring multiple similar objects using image templates.

### BACKGROUND

Before releasing a new printer or other consumer electronics device to market, the manufacturer generally tests a group of the devices for quality assurance. One common test is the “brute force” test. For example, a brute force test for a printer generally involves automatically testing each function, printing many pages, and so on. A manufacturer may dedicate a large number of the devices for these tests.

One problem encountered in performing this type of test is detecting when a printer has an error, such as a paper jam, firmware bug, or the like. Often an error goes undetected until a human operator discovers the problem. At that point it is often difficult to diagnose the problem.

One approach is to have a human operator continuously watch the printers under test, but this is not practical. What is needed is an automated solution.

### SUMMARY

In general, in one aspect, an embodiment features computer-readable media embodying instructions executable by a computer to perform a method comprising: capturing, with a first camera, a first image of a first one of a plurality of similar objects each having a common feature; generating an image template file based on the first image, wherein the image template file identifies a location of the feature of the first one of the plurality of similar objects in the first image; capturing, with a second camera, a second image of a second one of the plurality of similar objects; and controlling the second camera based on the second image and the image template file.

Embodiments of the computer-readable media can include one or more of the following features. In some embodiments, the method further comprises: controlling the second camera so that the feature of the second one of the plurality of similar objects occupies a location in the second image according to the location of the feature of the first one of the plurality of similar objects in the first image. In some embodiments, the method further comprises: identifying a region of interest in the first image; describing the region of interest in the image template file; and identifying the region of interest in the second image based on the image template file. In some embodiments, the method further comprises: recording changes that occur in the region of interest in the second image. In some embodiments, the method further comprises: recording changes that occur in the region of interest in the first image. In some embodiments, the region of interest comprises: the feature.

In general, in one aspect, an embodiment features an apparatus comprising: a master monitor unit comprising a first camera adapted to capture a first image of a first one of a plurality of similar objects each having a common feature, and a first computer adapted to generate an image template file based on the first image, wherein the image template file identifies a location of the feature of the first one of the plurality of similar objects in the first image; and a slave monitor unit comprising a second camera adapted to capture a second image of a second one of the plurality of similar objects, and a second computer adapted to control the second camera based on the second image and the image template file.

Embodiments of the apparatus can include one or more of the following features. In some embodiments, the second computer is further adapted to control the second camera so that the feature of the second one of the plurality of similar objects occupies a location in the second image according to the location of the feature of the first one of the plurality of similar objects in the first image. In some embodiments, the first computer is further adapted to identify a region of interest in the first image; wherein the first computer is further adapted to describe the region of interest in the image template file; and wherein the second computer is further adapted to identify the region of interest in the second image based on the image template file. In some embodiments, the second computer is further adapted to record changes that occur in the region of interest in the second image. In some embodiments, the first computer is further adapted to record changes that occur in the region of interest in the first image. In some embodiments, the region of interest comprises: the feature.

In general, in one aspect, an embodiment features a method comprising: capturing, with a first camera, a first image of a first one of a plurality of similar objects each having a common feature; generating an image template file based on the first image, wherein the image template file identifies a location of the feature of the first one of the plurality of similar objects in the first image; capturing, with a second camera, a second image of a second one of the plurality of similar objects; and controlling the second camera based on the second image and the image template file. Some embodiments comprise controlling the second camera so that the feature of the second one of the plurality of similar objects occupies a location in the second image according to the location of the feature of the first one of the plurality of similar objects in the first image. Some embodiments comprise identifying a region of interest in the first image; describing the region of interest in the image template file; and identifying the region of interest in the second image based on the image template file. Some embodiments comprise recording changes that occur in the region of interest in the second image. Some embodiments comprise recording changes that occur in the region of interest in the first image. In some embodiments, the region of interest comprises: the feature.

In general, in one aspect, an embodiment features an apparatus comprising: master means for monitoring comprising first means for capturing a first image of a first one of a plurality of similar objects each having a common feature, and means for generating an image template file based on the first image, wherein the image template file identifies a location of the feature of the first one of the plurality of similar objects in the first image; and slave means for monitoring comprising second camera means for capturing a second image of a second one of the plurality of similar objects, and means for controlling the second camera based on the second image and the image template file.

Embodiments of the apparatus can include one or more of the following features. In some embodiments, the means for controlling controls the second camera means so that the feature of the second one of the plurality of similar objects occupies a location in the second image according to the location of the feature of the first one of the plurality of similar objects in the first image. In some embodiments, the means for generating identifies a region of interest in the first image and describes the region of interest in the image template file; and wherein the means for controlling identifies the region of interest in the second image based on the image template file. In some embodiments, the means for controlling records changes that occur in the region of interest in the second image. In some embodiments, the means for generating records changes that occur in the region of interest in the first image. In some embodiments, the region of interest comprises: the feature.

The details of one or more implementations are set forth in the accompanying drawings and the description below. Other features will be apparent from the description and drawings, and from the claims.

### DESCRIPTION OF DRAWINGS

FIG. 1 shows a printer test system for testing N similar printers that include common features according to some embodiments.

FIG. 2 shows a process for the printer test system of FIG. 2 according to some embodiments.

FIG. 3 shows an example printer control panel.

The leading digit(s) of each reference numeral used in this specification indicates the number of the drawing in which the reference numeral first appears.

### DETAILED DESCRIPTION

The present disclosure relates in general to image processing, and in particular to monitoring multiple similar objects using image templates. The objects can be electronic devices such as printers of the same type being tested before release. However, while embodiments for monitoring printers are described below, various embodiments can be employed to monitor any group of similar objects.

According to the described embodiments, each printer is monitored by a respective monitor unit that includes a camera controlled by a computer. One of the monitor units is designated the “master” monitor unit. The master monitor unit's camera is “registered,” that is, controlled so that it captures features of the printer to be monitored. Registration can include controlling the orientation of the camera, the zoom factor of the camera, and the like. The registration of the master monitor unit's camera is generally manual, but can be automated.

The master monitor unit's camera captures an image of one of the printers. The master monitor unit's computer analyzes the image to identify one or more features that are common to each of the printers. These common features include “registration” features that can be used to automatically register the cameras of other monitor units, referred to as “slave” monitor units. The common features also include “regions of interest” to be monitored by the monitor units in order to evaluate the printers. For example, the features can include buttons, a display panel, and the like. Based on the analysis, the master monitor unit's computer generates an image template file that specifies the location in the image of each of the features, the type of each feature (button, light, display panel, etc.) and whether each feature is a registration feature, a region of interest, or both. The image template file is distributed to the slave monitor units.

Each slave monitor unit uses the registration features in the image template file to automatically register its camera so that its view matches the view of the master monitor unit's camera, thereby allowing the monitor units to automatically monitor operation of the printers. The slave monitor unit's camera captures an image of the printer being monitored by the slave monitor unit. The slave monitor unit's computer then operates the slave monitor unit's camera based on that image and the image template file. In particular, the slave monitor unit's computer analyzes the image to identify the registration features, and operates the camera so that the registration features occupy the same location in the images captured by the slave monitor unit's camera as in the images captured by the master monitor unit's camera. Once all the cameras are registered, the printers can be operated according to a test routine, with the monitor units recording changes in the regions of interest of the printers.

Automatic camera registration for the slave monitor units saves considerable time in the testing process, especially as the number of printers to be tested increases. Human intervention is generally only required for camera registration for the master monitor unit.

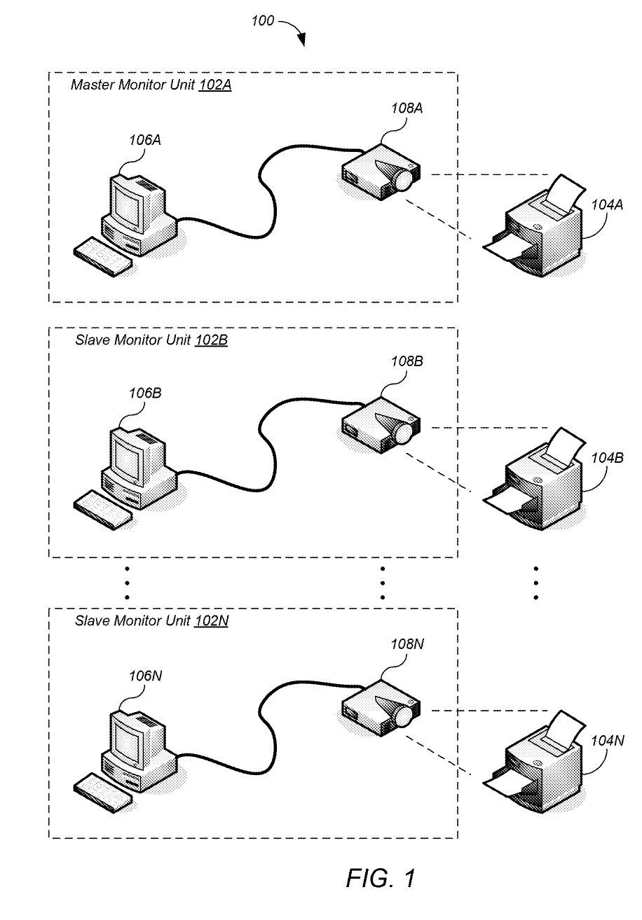

FIG. 1 shows a printer test system 100 for testing N similar printers that include common features according to some embodiments. Referring to FIG. 1, printer test system 100 includes N monitor units 102A-N each monitoring one of N printers 104A-N. Monitor unit 102A is designated the “master” monitor unit, while the remaining monitor units 102B-N are designated “slave” monitor units. Each monitor unit 102 includes a computer 106 and a camera 108 connected to the computer 106.

Although in the described embodiments, the elements of printer test system 100 are presented in one arrangement, other embodiments may feature other arrangements, as will be apparent to one skilled in the relevant arts based on the disclosure and teachings provided herein. For example, the elements of printer test system 100 can be implemented in hardware, software, or combinations thereof. For example, computers 106 can be implemented as general-purpose or special-purpose computers, as dedicated hardware units, or the like. Furthermore, while embodiments are described for monitoring printers, various embodiments can be employed to monitor any group of similar objects for visible changes.

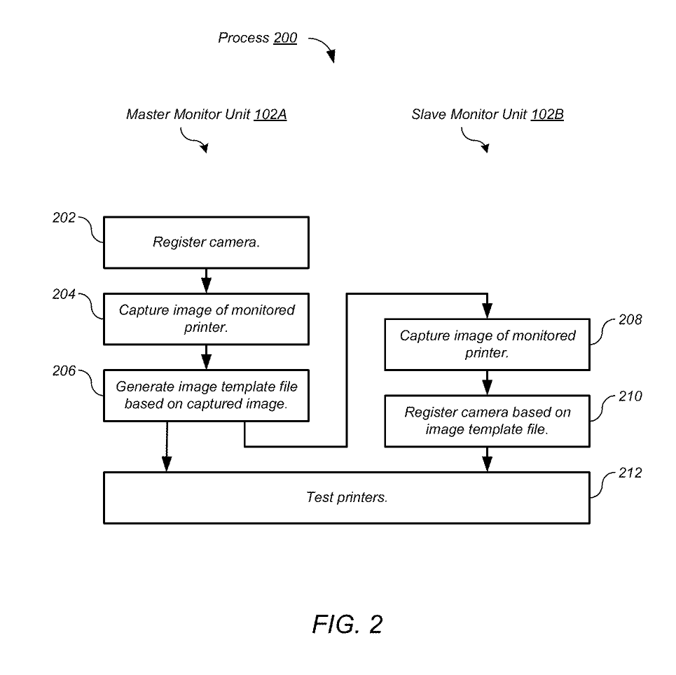

FIG. 2 shows a process 200 for printer test system 100 of FIG. 2 according to some embodiments. Although in the described embodiments, the elements of process 200 are presented in one arrangement, other embodiments may feature other arrangements, as will be apparent to one skilled in the relevant arts based on the disclosure and teachings provided herein. For example, in various embodiments, some or all of the steps of process 200 can be executed in a different order, concurrently, and the like.

Referring to FIG. 2, camera 108A of master monitor unit 102A is “registered” (step 202). That is, camera 108A is controlled to enable camera 108A to observe one or more regions of interest and registration features of printer 104A. In the current printer test example, this generally involves controlling camera 108A to observe a control panel of printer 104A. Registration of camera 108A is generally manual. That is, a human employs computer 106A to control the orientation and zoom factor of camera 108A. However, automatic registration is contemplated.

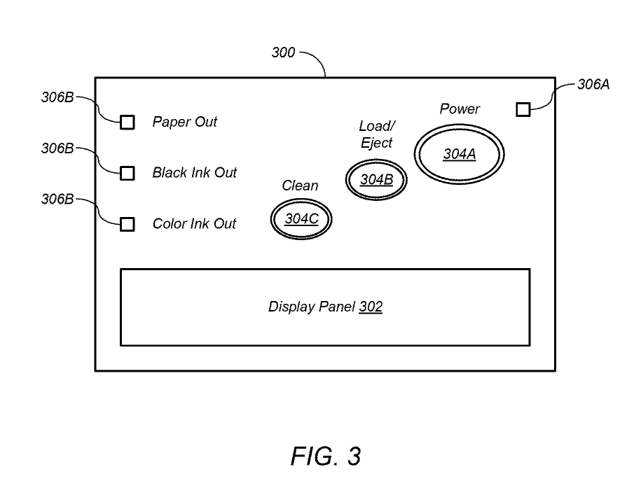

FIG. 3 shows an example printer control panel 300. In the current example, each printer 104 (FIG. 1) includes printer control panel 300. Referring to FIG. 3, control panel 300 has several features including a display panel 302, control buttons 304A-C, and indicator lights 306A-D. Suitable registration features of printer control panel 300 include display panel 302, buttons 304, and printer control panel 300 itself. Lights 306 generally do not make good registration features, but can be used as such. Suitable regions of interest include display panel 302 and lights 306. Note that a feature can be used as both a registration feature and a region of interest.

Referring again to FIG. 2, after registration, camera 108A captures an image of printer 104A (step 204). In the current example, camera 108A captures an image of printer control panel 300 of printer 104A. The image, referred to herein as the “master image,” can be a still photograph, a frame of video, or the like.

Computer 106A generates an image template file based on the captured image (step 206). The image template file identifies the location of each of the common features, and labels each common feature in the captured image as a registration feature, a region of interest, or both.

For example, computer 106A of master monitor unit 102A can execute an application to generate the image template file. The application enables the user to specify the registration features and regions of interest in the captured image. The user selects registration features and regions of interest in the captured image. Control panel 300 is initially automatically selected. Lights 306 generally need to be selected by the user, as they are small and difficult to detect automatically.

A model-based method is used to find registration features and regions of interest, which are generally rectangles and ellipses. Circles are also recognized as they are a special case of an ellipse (circular buttons usually appear as ellipses from the camera's viewpoint). This feature detection can be based on edges. The edges are analyzed for ellipses (such as buttons 304) and rectangles (such as control panel 300 and display panel 302). An edge map is produced. Because the edges of buttons 304 and the display panel 302 are strong, a Canny edge detector can be used to produce the initial edge map.

Next small components are filtered out. Morphological operations can be used. The edge map is eroded and then dilated. Components that are less than 5% of the image's width and height are removed. Components with thin edges (for example, edges that are only one or two pixels wide) are also removed. The edge map is then dilated and eroded to connect holes in components.

Next the edge map is examined for rectangles and ellipses. A Hough transform can be used for this process. Once the rectangles and ellipses are found, their locations are saved in the image template file. The user can label each as a registration feature, a region of interest, or both. The labels are also recorded in the image template file.

The image template file is then transferred to each of the slave monitor units 102B-N, which then perform camera registration based on the image template file. Camera registration is described for one of the slave monitor units 102B, but is similar for all slave monitor units 102B-N.

Referring again to FIGS. 1 and 2, camera 108B of slave monitor unit 102B captures an image of printer 104B (step 208). In the current example, camera 108B captures an image of printer control panel 300 of printer 104B. The image, referred to herein as the “slave image,” can be a still photograph, a frame of video, or the like.

Computer 106B of slave monitor unit 102B then registers camera 108B based on the slave image and the image template file (step 210). In particular, computer 106B controls camera 108B so that the features identified in the image template file occupy a location in the slave image according to the location of the features in the master image.

For example, the model-based method described above is used to find objects such as rectangles and ellipses in the slave image. The ellipses and rectangles in both the master and slave images are grouped by size and then sorted by the number of objects in each group. These lists, referred to respectively as the “master list” and “slave list,” are compared to register slave camera 108B.

A brute force comparison is made between the two lists. In particular, an object is selected from the master list. The center of the object is translated to a coordinate origin. A corresponding object is selected from the slave list and translated to the origin. This sets the x and y location for the objects in the slave list.

Next a z value (also referred to as the zoom factor) is selected. The z value is set by the size of the objects being tested. The z value of the objects in the slave list is adjusted by the ratio of the object selected from the master list and the corresponding object from the slave list.

Next a rotation value (that is, the angle of rotation of the image) is selected. This can be done by brute force. Rotation values are looped through for +/−10%, in 0.5 degree increments. The z value can be adjusted for each rotation value. For each rotation value, a metric is computed that describes how well each object in the two lists geometrically fit together. The metric can include, for example, the number of objects that overlap, the offset between the centers of overlapping objects, and the difference in scale of overlapping objects. This process can be repeated for the top objects in the master list. These metrics make up a feature vector that can be compared with other rotations. The metrics are normalized based on the maximums of all the vectors, and multiplied together. The rotation value associated with the vector with the highest score is chosen.

After slave camera 108B is registered, the testing of printers 104 can begin (step 212). That is, each slave monitor unit 102B-N records changes that occur in the regions of interest in the images captured by the slave cameras 108B-N. In addition, master monitor unit 102A can record changes that occur in the regions of interest in the images captured by the master camera 108A. Change recognition is now described for one monitor unit 102, but is similar for all monitor units 102.

To recognize changes, an image of printer 104 is captured by camera 108. This image is compared to a previously captured image. A difference map is computed, for example by subtracting one of the images from the other and taking the absolute value of the difference. This difference represents the amount of change for each pixel. The difference map is then thresholded to remove noise and inconsequential changes. Changes outside the regions of interest are ignored.

Change detection differs between lights 306 and display panel 302. For lights 306, color information is considered. For example, the difference map is generated in a color space. To reduce sensitivity to changes in lighting, the color channels of the two images are first normalized.

Display panel 302 presents a challenge in that the illumination of display panel 302 should not be recognized as a change. To mitigate this effect, the color space of the two images is converted to the HSV color space. The V channel is normalized between the two images. The difference map described above is then generated for the V channel only.

When a light 306 changes, or the text in display panel 302 changes, the change is recorded and sent to master computer 106A for analysis. The analysis can include recognizing the condition of a light 306 (for example, on or off, blinking or solid, color, and the like), recognition of error messages in display panel 300 (for example, printer jam, out of paper, and the like), and the like. Other analyses are contemplated.

Various embodiments can be implemented in digital electronic circuitry, or in computer hardware, firmware, software, or in combinations of them. Embodiments can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations have been described. Nevertheless, it will be understood that various modifications may be made without departing from the spirit and scope of this disclosure. Accordingly, other implementations are within the scope of the following claims.

What is claimed is:

1. Computer-readable media embodying instructions executable by a computer to perform a method comprising:
capturing, with a first camera, a first image of a first one of a plurality of similar objects each having a common feature;
generating an image template file based on the first image, wherein the image template file identifies a location of the feature of the first one of the plurality of similar objects in the first image;
capturing, with a second camera, a second image of a second one of the plurality of similar objects; and
controlling the second camera based on the second image and the image template file.

2. The computer-readable media of claim 1, wherein the method further comprises:
controlling the second camera so that the feature of the second one of the plurality of similar objects occupies a location in the second image according to the location of the feature of the first one of the plurality of similar objects in the first image.

3. The computer-readable media of claim 1, wherein the method further comprises:
identifying a region of interest in the first image;
describing the region of interest in the image template file; and
identifying the region of interest in the second image based on the image template file.

4. The computer-readable media of claim 3, wherein the method further comprises:
recording changes that occur in the region of interest in the second image.

5. The computer-readable media of claim 4, wherein the method further comprises:
recording changes that occur in the region of interest in the first image.

6. The computer-readable media of claim 3, wherein the region of interest comprises:
the feature.

7. An apparatus comprising:
a master monitor unit comprising
a first camera adapted to capture a first image of a first one of a plurality of similar objects each having a common feature, and
a first computer adapted to generate an image template file based on the first image, wherein the image template file identifies a location of the feature of the first one of the plurality of similar objects in the first image; and
a slave monitor unit comprising
a second camera adapted to capture a second image of a second one of the plurality of similar objects, and
a second computer adapted to control the second camera based on the second image and the image template file.

8. The apparatus of claim 7:
wherein the second computer is further adapted to control the second camera so that the feature of the second one of the plurality of similar objects occupies a location in the second image according to the location of the feature of the first one of the plurality of similar objects in the first image.

9. The apparatus of claim 7:
wherein the first computer is further adapted to identify a region of interest in the first image;
wherein the first computer is further adapted to describe the region of interest in the image template file; and
wherein the second computer is further adapted to identify the region of interest in the second image based on the image template file.

10. The apparatus of claim 9:
wherein the second computer is further adapted to record changes that occur in the region of interest in the second image.

11. The apparatus of claim 10:
wherein the first computer is further adapted to record changes that occur in the region of interest in the first image.

12. The apparatus of claim 9, wherein the region of interest comprises:
the feature.

13. An apparatus comprising:
master means for monitoring comprising
first means for capturing a first image of a first one of a plurality of similar objects each having a common feature, and
means for generating an image template file based on the first image, wherein the image template file identifies a location of the feature of the first one of the plurality of similar objects in the first image; and
slave means for monitoring comprising
second camera means for capturing a second image of a second one of the plurality of similar objects, and
means for controlling the second camera based on the second image and the image template file.

14. The apparatus of claim 13:
wherein the means for controlling controls the second camera means so that the feature of the second one of the plurality of similar objects occupies a location in the second image according to the location of the feature of the first one of the plurality of similar objects in the first image.

15. The apparatus of claim 13:
wherein the means for generating identifies a region of interest in the first image and describes the region of interest in the image template file; and
wherein the means for controlling identifies the region of interest in the second image based on the image template file.

16. The apparatus of claim 15:
wherein the means for controlling records changes that occur in the region of interest in the second image.

17. The apparatus of claim 16:
wherein the means for generating records changes that occur in the region of interest in the first image.

18. The apparatus of claim 15, wherein the region of interest comprises:
the feature.
